(19) United States
(12) Patent Application Publication
(10) Pub. No.: US 2011/0215808 A1
(43) Pub. Date: Sep. 8, 2011

(54) PASSIVE UNDERGROUND ELECTRONIC MARKER FOR USE IN ANY ORIENTATION

(76) Inventor: SAMEER CHOLAYIL, FORT WORTH, TX (US)

(21) Appl. No.: 12/718,173

(22) Filed: Mar. 5, 2010

(51) Int. Cl. G01V 3/08

(52) U.S. Cl. 324/326; 340/572.5

(57) ABSTRACT

A passive electronic marker comprising a single tuned LC circuit, having an inductance and one capacitance element, that respond substantially uniformly to a marker locating instrument irrespective of the orientation the marker was installed in. The inductance is split among more than one electrically contiguous coils; each of the coils is oriented in different axes along the three dimensional space to achieve the substantially uniform response to a marker locating instrument. The tuned circuit is enclosed in a protective housing that may or may not help in the orientation of the marker during burying. The passive marker is of a type that is buried relative to portions of an object for use in locating such objects when necessary.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The invention presented here relates to passive electronic markers of tuned capacitance-inductance type for use in locating buried objects by virtue of proximity to the marker buried alongside the object; more particularly to type of markers that can be buried without care to orientation of the marker installed.

### BACKGROUND OF THE INVENTION

Prior art, U.S. Pat. No. 3,836,842, issued 1974, describes the passive marker as a tuned inductance-capacitance circuit, comprising a coil of conductive wire as inductance connected to a capacitor and tuned to the desired frequency. This assembly is encapsulated in non magnetic material for protection. Most modern passive markers and locators may be considered as variations of this prior art. The said prior art also describes a marker locating device. The marker locating device operates by transmitting an alternating magnetic field, this induces a current in the tuned passive marker circuit in proximity of the locating device. The locating device stops transmission and tries to receive, in the same axis as the transmitter, the magnetic field transmitted from the marker due to the current that resonate inside the passive marker before the current decays and thus detect the presence or absence of a passive marker. The said prior art also describes the detection profile with respect to marker depth. The maximum detection depth varies with soil and environmental conditions too. Prior art, U.S. Pat. No. 4,873,533, issued 1989, describes the typical turns in a coil that forms the inductance, typical capacitance value range, materials used, detection range and dimensions to give us an idea about these parameters.

Modern passive markers are mainly air cored markers that may be broadly divided into two types, a flat type and spherical type. Prior art, U.S. Pat. No. 4,334,227, issued 1982, describes a typical flat type of marker. This is a single frequency tuned Inductance-capacitance circuit with the coil in a flat plane and axis perpendicular to the plane of the coil. The problem with this type of marker is that the axis needs to be properly aligned with the marker locating devices transmitting and receiving antenna. This means that if the work site crew buries the flat marker without care to orientation, then detecting the marker becomes difficult or impossible depending on the size of the marker and the depth that it is at and the position of the marker coil axis. Underground movements of soil or differential settlement in a water logged site can also cause the marker to change orientation even after proper installation and may occur after many years making locating the marker difficult.

Prior art, U.S. Pat. No. 4,712,094, issued 1987, describes a spherical marker with a flat marker coil inside which aligns the coil axis in the direction of gravity. Thus this invention solves the problem of deliberate marker orientation requirement in the vertical direction by floating a flat marker in a liquid. The disadvantages with this arrangement are, added weight of the liquid, sealing requirements for heavy fluid, additional sealing requirement for the internal coil separate from outer shell, added cost of the materials and anti-freeze requirements for the liquid. Handling is consequently not smooth with liquid sloshing inside and added shipping cost. Additional sealing for coil and its need to move freely inside the marker means that the coil size is smaller relative to the marker further reducing the marker detection range. The marker does not provide maximum orientation free detection in directions other than vertical. For example, if installed on a slope above a flat area, this marker will be hard to detect walking along the flat area around the rising slope.

One way to get a true multidirectional response is, align flat markers in all three axes in one package. This kind of a solution is given in prior art, U.S. Pat. No. 5699048, issued 1997, which describes another spherical marker that overcomes the shortcomings with prior art, U.S. Pat. No. 4,712,094. It uses 2 or more isolated inductance-capacitance tuned circuits, each in a separate axis for improved multidirectional detectability. Diagram in FIG. 2. is from the above prior art and shows the approximation of the multidirectional response 27 of these markers from the three tuned circuit 11, 17, 23 each in a separate axis. A disadvantage with this type of marker is the need for more than one isolated tuned circuit per axis, normally three, which adds to material, assembly time and labor cost and assembly complexity. Another disadvantage is that it includes more components leading to lower reliability than a single tuned circuit due to increased number of components and increased number of joints between the capacitors and the inductors. Another disadvantage is that three coils have to be wound, capacitor joined to each coil and each of the circuits tuned individually before final assembly of the marker begins. The other disadvantage of this prior art is that the multidirectional response from prior art in FIG. 2. is only applicable when both the transmitter and the detector of the marker locating instrument are in the same axis. In other words, if the marker is buried deep enough and say, the axis of the transmitter of the marker locating device is in the Y-axis of FIG. 2, only the coil with Y-axis is receiving the magnetic flux from the transmitter and consequently generating a magnetic field at that instant. There is very little magnetic flux linkage in the vertical coils in X-axis and Z-axis as at that distance magnetic flux lines from the transmitter are almost parallel to the vertical Y-axis. As a result a receiver in the X-axis or Z-axis will see very little signal if the marker is not very near to it.

### BRIEF SUMMARY OF THE INVENTION

A single capacitance-inductance tuned circuit passive marker constructed in accordance with the present invention provides a true multidirectional response under all conditions, without a plurality of separate isolated tuned circuits, allowing orientation free marker. A passive marker constructed in accordance with the invention comprises two or more electrically contiguous coils oriented in three dimensional space such that the axes of the coils are at different positions or angles to each other; a capacitance, which together with the combined inductance of the coils, tune the circuit to a frequency; and a housing to enclose and insulate the said tuned circuit from the locating instrument as well as protect the said tuned circuit from common substances in the soil.

The other advantages of this invention are that there are no liquids and anti-freeze inside the marker, this marker is lighter than a liquid filled marker, the coils do not need a second enclosure to protect from liquid inside the marker, the coils in the marker can be as big as the enclosure depending on the coil arrangement and the response is mostly uniform in three dimensional space as opposed to a floated flat marker.

The additional advantages of this invention are that, each of the coils need not tuned individually, this results in lower number parts, joints and labor and consequently higher reliability, coils need not be wound, tuned and readied before assembly, continuous winding one coil after another is possible as the coils are not electrically isolated from one another.

The response from this invention is more uniform in all 3 dimensions as the same current flows in all 3 coils with axis oriented differently. This generates uniform magnetic field available for detection. This is true even when the transmitter and detector axes are at any angle to each other.

Markers that respond to two or more frequencies are possible by using a plurality of, single inductance-capacitance tuned multiaxis coil circuits, tuned to multiple frequencies. Markers that respond with higher response are possible by using a plurality of such single inductance-capacitance tuned multiaxis coil circuits tuned to the same frequency.

### BRIEF DESCRIPTION OF THE SEVERAL VIEWS OF THE DRAWING

FIG. 1 is a partial cutaway view of one preferred embodiment of the present invention.

FIG. 2 is an illustration of the directional pattern of the three isolated tuned circuits from a prior art as described in the background of the invention.

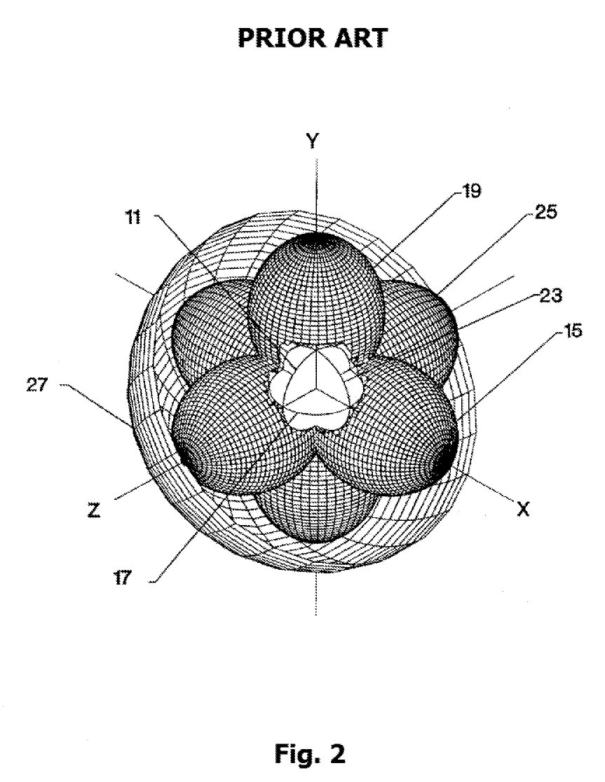

FIGS. 3A and 3B are diagrams of the contiguous single inductance-capacitance tuned coils used to get multidirectional response as per other embodiments.

### DETAILED DESCRIPTION OF THE INVENTION

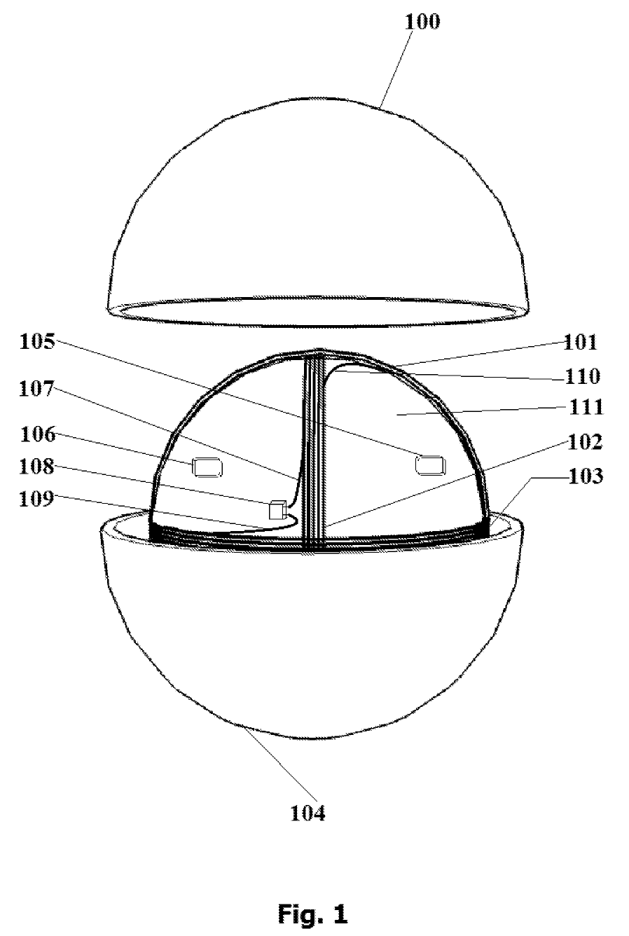

The invention described here provides a solution that allows a better orientation free passive marker. FIG. 1 discloses one embodiment of the invention wherein a Styrofoam ball 111 acts as a self channel forming former to the three orthogonal bands of coils 101, 102, 103 in electrical series, the capacitance 108 in series to the set of series coils forming a single inductance-capacitance tuned circuit. The coils are made from an insulated conductor. Foam shock absorbers like 105, 106 are placed on each surface sector of the ball to protect the coils from hitting the enclosure inner surface. The ball with tuned circuit is placed inside the two halves 100, 104 of the enclosure and the enclosure is sealed to isolate the coils electrically and physically. It is to be noted that the enclosure is permeable to magnetic field.

Consider X-axis to be from the left to right of FIG. 1, Y-axis to be from top to bottom of FIG. 1. and Z-axis as going into the figure. To assemble the invention, the coil 102 is wound on the ball 111 starting with the end 107 of the coil 102 in clockwise direction in z-axis growing from left to right and ending with at plane transition point 110. The coil 102 is now taped in place. Now the ball is turned 90 degrees in clockwise along x-axis and coil 101 is wound in z-axis in the clockwise direction growing from right to left. The end of coil 101 is not shown in the diagram, but it is taped and coil 103 is now wound in clockwise direction along x-axis and grows from bottom to top. The end of coil 103 is 109. All the coils and transition points are taped and glued in place. The insulation of ends 107 and 109 are removed and a capacitor 108 is joined to the free ends of coils at 107 and 109 by first twisting together the coil ends to the capacitor leads. The joints at 107 and 109 are then welded. Higher density foam pieces like 105 and 106 are attached to each sector of the ball to provide shock protection to the coil assembly. The coil assembly is now placed in the two high density polyethylene hemispheres 100, 104 that form the enclosure. Spin welding is used to fuse together the two hemispheres to complete the invention described here.

The theory behind operation of a typical passive marker and marker locating device is briefly explained in the background of the invention. Assuming that the marker is buried fairly deep underground with orientation as in FIG. 1, the transmitter in a marker locating device directly above ground will induce most current in the coil 103, with very little current in coils 101 and 102. The resultant current flowing in the single tuned circuit will still generate equal magnetic fields in all three coils in all 3 axes and hence a receiver can receive these signal in any direction. This is a unique feature of this invention that allows the transmitter and detector not be in the same axis. Since the marker of the invention is buried without care to orientation, some current will always be induced in all the three coils and will add up as care has been taken about the winding direction of each coil generating a stronger and equal magnetic field. The magnetic field generated by the equal resonant current in the three coils in series will also add up and produce a better multidirectional response to a marker locating instrument.

Another embodiment of the invention may have coil bands 101, 102, 103 of FIG. 1. made separately. The coils 101 and 102 are then joined together at transition point 110 by soldering or welding the separate coils. Similarly, end of coils 101 and 103 not shown in FIG. 1. also needs to be joined together. The coils can all be slightly different sizes from one another for ease of forming the three coil assembly instead of bending coils into place. In this case ball former 111 of FIG. 1. is not needed.

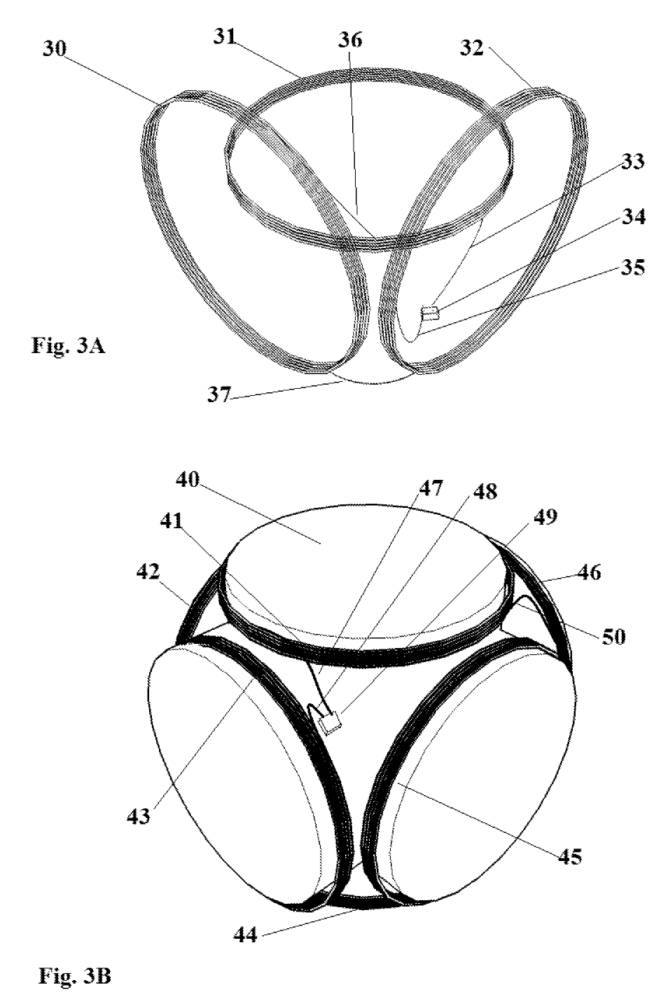

FIG. 3A and FIG. 3B shows alternate coil assembly arrangements for other embodiments of the invention. In FIG. 3A 30, 31, 32 are coils with 3 axes that are orthogonal but not concentric. 34 is the capacitor of the tuned circuit. 33, 35, 36, 37 are ends or beginnings of the coils connected in series. In FIG. 3B, 41, 42, 43, 44, 45, 46 are coils with another arrangement. 49 is the capacitor of the tuned circuit. 47, 48, 50 are visible ends or beginnings of the coils connected in series. The coils are wound on the former 40. The coil assembly may also be a mesh of single turn coils made out of LITZ wire in all angles, in affect a mesh of single turn coils.

Another embodiment of the invention may have the enclosure halves 100, 104 with lips so that they can be joined by ultrasonic or heat welding. The enclosure halves may also have projections that allow the marker to be tied to an object.

Only a few embodiments that fall within the scope and spirit of the present invention have been described here.

I claim:

1. A passive electronic marker for use in locating buried objects, comprising:
a) a single capacitance-inductance tuned circuit.
b) said inductance comprising two or more electrically contiguous coils oriented in three dimensional space such that the axes of said coils are at different positions or angles to each other.
c) said capacitance, which together with the said inductance, tune the said circuit to one desired frequency.
d) a housing to enclose and protect the said tuned circuit.
e) said marker being buried without care of the orientation and being able to detect the said marker with a locating instrument more uniformly in any orientation.

2. A passive marker of claim 1 that can be located uniformly by a receiver in any axis when energized by a transmitter in any other axis.

3. A passive electronic marker for use in locating buried objects, comprising:
a) a plurality of tuned circuits of claim 1, enclosed in a housing and buried.
